(19) United States
(12) Patent Application Publication
(10) Pub. No.: US 2004/0062551 A1
(43) Pub. Date: Apr. 1, 2004

(54) Method and apparatus for load switching in hybrid RF/free space optical wireless links

(75) Inventors: Tamer Abdel Mottalib ElBatt, Woodland Hills, CA (US); Hossein Izadpanah, Newbury Park, CA (US)

Correspondence Address: Ross A. Schmitt, ESQ., c/o LADAS & PARRY, Suite 2100, 5670 Wilshire Boulevard, Los Angeles, CA, 90036-5679, US

(73) Assignee: HRL LABORATORIES, LLC.

(21) Appl. No.: 10/629,327

(22) Filed: Jul. 28, 2003

Related U.S. Application Data
(60) Provisional application No. 60/399,659, filed on Jul. 29, 2002.
(60) Provisional application No. 60/399,657, filed on Jul. 29, 2002.

(51) Int. Cl. H04B 10/10

(52) U.S. Cl. 398/115; 398/119; 398/162

(57) ABSTRACT

The present invention provides an algorithm for partitioning a portion of a load between a FSOW link and a RF link in order to maintain a FSOW link. By having the ability to adjust the load between a FSOW and RF wireless link during inclement weather, the ability to maintain the FSOW link is significantly increased. The algorithm of the present invention uses the BER to determine the current atmospheric attenuation and whether or not a percentage of the load is to be partitioned to the RF link. Using the BER to determine the actual atmospheric attenuation provides a better characterization of the link status, than other techniques such as the difference between the transmitted and received power. Once such a determination is made, a control circuit is used to partition a percentage of the load from the FSOW link onto the RF link.

### CROSS-REFERENCE TO RELATED APPLICATIONS

The present document claims the benefit of U.S. Provisional Application No. 60/399,659, filed Jul. 29, 2002, the contents of which are incorporated by reference herein. The present document is also related to the co-pending and commonly assigned patent applications entitled “Proactive Techniques For Sustenance Of High-Speed Fixed Wireless Links” U.S. Ser. No. 60/399,657 and “Hybrid RF And Optical Wireless Communication Link and Network Structure Incorporating It Therein” U.S. Ser. No. 09/800,917. The contents of these related applications are hereby incorporated by reference herein.

### FIELD

A method and apparatus for improving the quality and speed of wireless links between two remote sites are provided. More specifically, a novel dynamic load switching algorithm which enhances the link availability of a free space optical wireless (FSOW) network and accurately characterizes the status of the FSOW link is provided.

### BACKGROUND

The concept of dynamic load switching has been widely employed to improve performance of wired communication networks. Within the context of wired networks, traffic switching or rerouting has been used in order to avoid congested links or hot spots in the network, and hence, achieve “load balancing.” This, in turn, leads to distributing the offered traffic uniformly over the network links and has been shown to increase the network capacity. Three references which discuss this technique are Lemma Hundress, Jordi Domingo Pascual “Fast Rerouting Mechanism for a Protected Label Switched Path,” Departament d'Arquitectura de Computadors, Universitat Politecnica de Catalunya, Jeyakesavan Beerasamy, S. Venkatesan, J. C. Shah “Effect of Traffic Splitting On Link and Path Restoration Planning,” IEEE, 1994, pp. 1867-1871, and Krishnan Balakrishnan, David Tipper, Deep Medhi, “Routing Strategies for Fault Recovery in Wide Area Packet Networks,” IEEE, 1995, pp. 1139-1143.

Load switching has also been used in RF wireless networks in order to overcome the effects of link quality degradation due to the use of multiple users, or mobile movement of the users. For instance, call hand-offs in cellular systems can be thought of as a type of load switching where the traffic load is transferred in full from one base station to another due to the movement of a cellular user in a car. This technique is discussed in Jun Li, Roy Yates, Dipankar Raychaudhuri, “Performance Analysis on Path Rerouting Algorithms for Handoff Control in Mobile ATM Networks, IEEE, 1999, pp. 1195-1203.

There is an increasing need for high data rate connectivity among users in metropolitan area network environments. Providing high-speed wireless extensions to the fiber optic backbone, also known as the “last-mile problem,” is the key challenge toward realizing this objective. Although wireless connectivity is an attractive solution due to its ease of use and low cost of installation, classical RF system bandwidth is limited and cannot fully utilize the high bandwidth offered by the fiber optics backbone. Therefore, “Broadband Wireless Backbone” connectivity architecture based on emerging FSOW links has been recently introduced as a potential solution to the last-mile problem. However, optical wireless links are highly sensitive to severe weather conditions (e.g. dense fog, etc.) which cause atmospheric attenuation to reach high levels, resulting in link failure. Furthermore, experimental results have recently shown that optical wireless links alone cannot achieve 99.999% availability figures over long distances and high data rates. These results are discussed in G. Clark, H. Willebrand and M. Achour, “Hybrid Free Space Optical/Microwave Communication Networks: A Unique Solution for Ultra High Speed Local Loop Connectivity,” Proceedings of SPIE, vol. 4214, 2001, pp. 46-54. Another reference which discusses this technique is J. P. Dodley, D. M. Britz, D. J. Bowen, C. W. Lundgren, “Free Space Optical Technology and Distribution Architecture for Broadband Metro and Local Services,” Proceedings of SPIE, Vol. 4214, 2001, pp. 72-85.

Several methods are discussed in the G. Clark, H. Willebrand and M. Achour reference for improving the FSOW link availability figures during inclement weather. One method to improve these figures is to scale down the distance between each transmitter-receiver pair using multi-hop routing. In multi-hop routing, a series of repeaters or similar devices are placed between the transmitter-receiver pair. The repeaters improve the quality of the FSOW link by reducing the effective distance the FSOW link must travel before reaching a repeater or the receiver.

However, scaling down the distance is not always feasible due to the geographical locations of buildings in metropolitan areas. Other methods involve increasing the power of the optical signal, or using optical signals with a wavelength of 1500 nanometers, instead of 850 nanometers. These methods are feasible, but aren't necessarily economical. Furthermore, using high power optical signals at any wavelength may create other health risks.

Presently, many systems using RF and FSOW links implement an all or nothing scheme. In this scheme, either 100% of the load is transmitted on the RF link, or 100% of the load is transmitted on the FSOW link. The load is not partitioned between both the RF link and the FSOW link. Therefore, there is a need for a system that can partition the load between a FSOW and RF link, during changing conditions and accurately characterize the conditions of the link.

### SUMMARY

In order to meet the aforementioned needs, a method and apparatus for maintaining a FSOW link is provided. The apparatus provides an algorithm which determines a quality indicator of the FSOW link, such as atmospheric attenuation. The algorithm compares the actual attenuation with a permissible attenuation of the FSOW link to determine whether a portion of the load on the FSOW link should be placed on a RF link. When the algorithm determines that a portion of the load on the FSOW link should be placed on the RF link a signal is sent to a control circuit. The control circuit then partitions the load and places part of the partitioned load on the RF link.

### BRIEF DESCRIPTION OF THE DRAWINGS

FIG. 1 presents a flow chart of an algorithm;

FIG. 2 shows an exemplary model of the present system;

FIGS. 3a and 3b show graphs of the bit error rate vs. average received power during different time periods;

FIGS. 4a-4d show the averaged bit error rates for a 24-hour period for a window length of 1 minute—100 minutes;

FIG. 5 shows a graph comparing the relative received signal power vs. bit error rate;

FIG. 6 shows a graph comparing the permissible attenuation vs. data rate; and

FIG. 7 shows the control circuit used to implement the algorithm of the present invention.

### DETAILED DESCRIPTION

The present invention will now be described more fully hereinafter with reference to the accompanying drawings, in which preferred embodiments of the invention are shown. This invention may be embodied in many different forms and should not be construed as limited to the embodiments set forth herein.

The present invention provides an apparatus employing an algorithm which attempts to improve the availability of FSOW links and mitigate its sensitivity to severe weather conditions that cause high levels of atmospheric attenuation resulting in link failure by allowing a portion of the load on the FSOW link to be transferred to an RF link. This algorithm also uses the bit error rate of the load on the FSOW link to accurately characterize the FSOW link quality. This algorithm is motivated by the fact that FSOW links and RF links are complementary with respect to weather sensitivity; while FSOW links suffer severe degradation from small size particles such as mist and fog, RF links are far less impacted by these weather conditions. On the other hand, RF links fade severely under heavy rain conditions, while FSOW are much less affected by heavy rain conditions. By using an RF link as a back-up link to the FSOW link, the desired data transmission rate can be maintained during inclement weather.

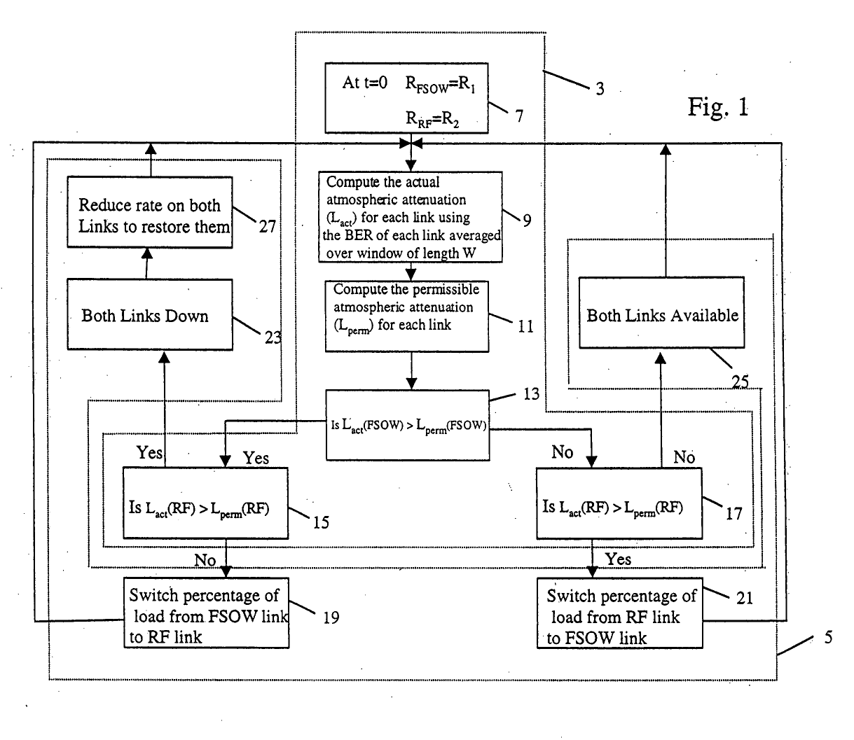

Shown in FIG. 1 is the algorithm 1 according to the present invention. The algorithm 1 may be written and implemented in C for example, or other software program using a computer or control device. The algorithm is divided into two main sub-algorithms, the “Instantaneous Link Availability” (ILA) algorithm 3, and the “Dynamic Load Switching,” (DLS) algorithm 5.

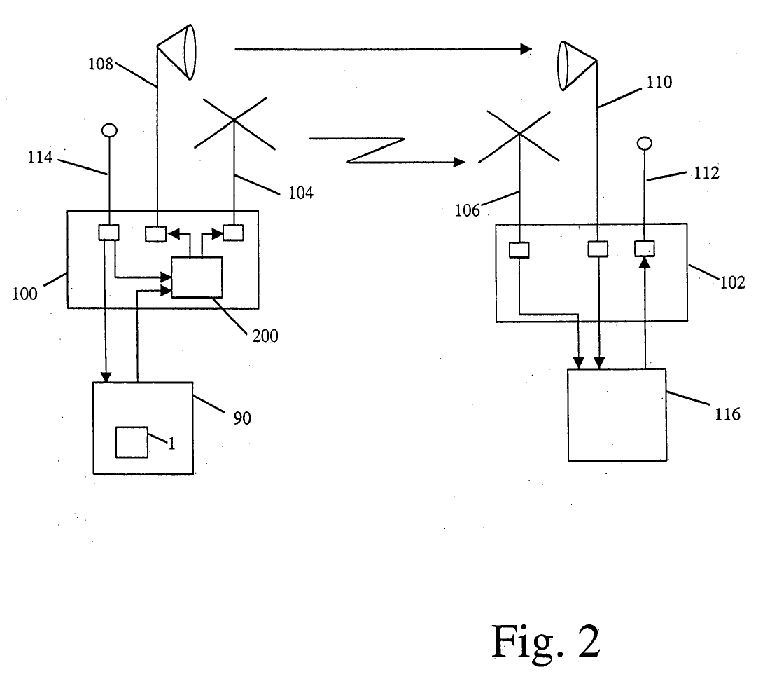

In order to implement the algorithm 1 of the present invention, a transmitter station 100 and receiver station 102 are provided, as shown in FIG. 2. A control device 90 comprising a computer or similar device is coupled to the transmitter station 100, and executes the algorithm 1. The control device 90 may comprise a computer or similar device and is coupled to the transmitter station 100. The transmitter station 100 has a RF transmitting antenna 104 and the receiver station 102 has a RF receiving antenna 106. This creates the RF link. The transmitter station 100 has an optical transmitter 108 and the receiver station 102 has an optical receiver 110. This creates the FSOW link. In addition, the receiver station 102 contains a RF feedback transmitter 112 and the transmitter station 100 has an RF feedback receiver 114, thereby creating a feedback link. The RF feedback transmitter and receiver 112, 114 will be discussed later. It should also be noted that the feedback link may comprise an optical link instead of an RF link. In addition, the receiver station 102 contains a measuring device 116 coupled to the optical receiver 110, which is discussed later.

In order to understand the algorithm 1, the notion of ILA must be introduced. The ILA algorithm 3 is used to accurately reflect the status of the FSOW and RF links under the current conditions, e.g., weather. The ILA algorithm 3 periodically calculates the actual atmospheric attenuation on both the FSOW and RF links. If the atmospheric attenuation becomes too high, causing the bit error rate (BER) to exceed a pre-determined threshold, then the DLS algorithm 5, discussed later, is implemented.

The ILA algorithm 3, shown in FIG. 1, consists of several blocks. The first block 7 records at a starting time point, shown in FIG. 1 as t=0, the current data rates of the FSOW and RF links. Shown in FIG. 1, the FSOW link has a load, R₁, and the RF link has a load, R₂. The value of R₁ and R₂ can be any desired rate of data transmission. For purposes of experimentation only, an initial data rate of 622 Mbps was used for R₁ in an OC-12 link and an initial data rate of 0 Mbps was used for R₂.

Next, the second block 9 of the ILA algorithm 3 computes the actual atmospheric attenuation for the FSOW link using equation 1.

A=Pₜ−Pᵣ Equation 1

A=actual atmospheric attenuation

Pₜ=transmitted power of the load by the optical transmitter 108 in FIG. 1

Pᵣ=power in the load received by the optical receiver 110 in FIG. 1

Equation 1 can also be used to calculate the actual atmospheric attenuation of the RF link, if desired, except the average received power is the average received power by the RF receiver 106 and the transmitted power is the power transmitted by the RF transmitter 104. In equation 1, the transmitted power of the load is a known quantity. The average received power is calculated by first finding the BER of the link. Although it is possible to determine the actual atmospheric attenuation directly from equation 1, directly measuring the received power to determine the actual atmospheric attenuation is not always a good indication of the attenuation in FSOW link as discussed below.

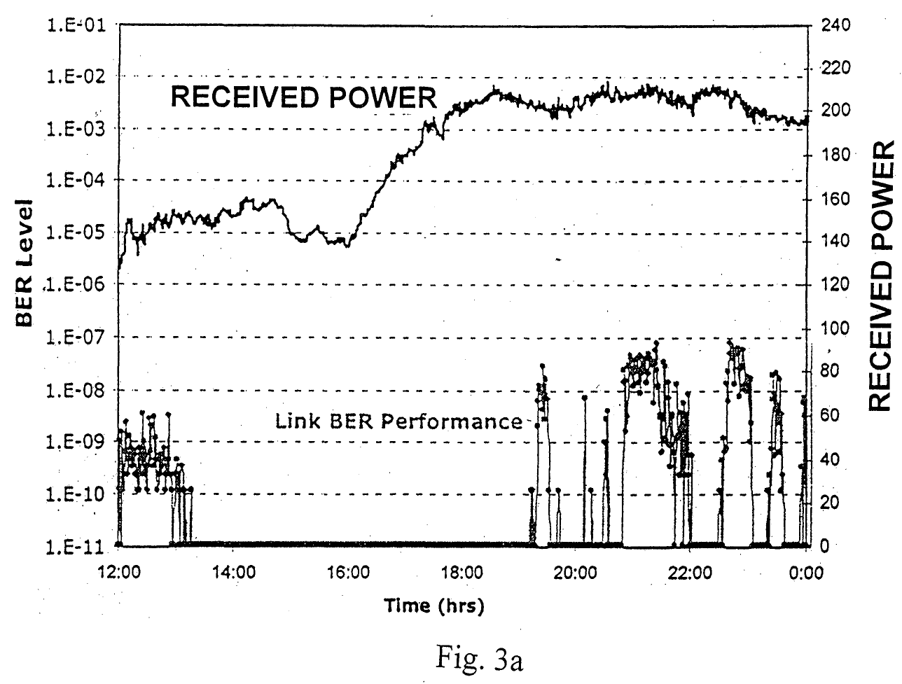

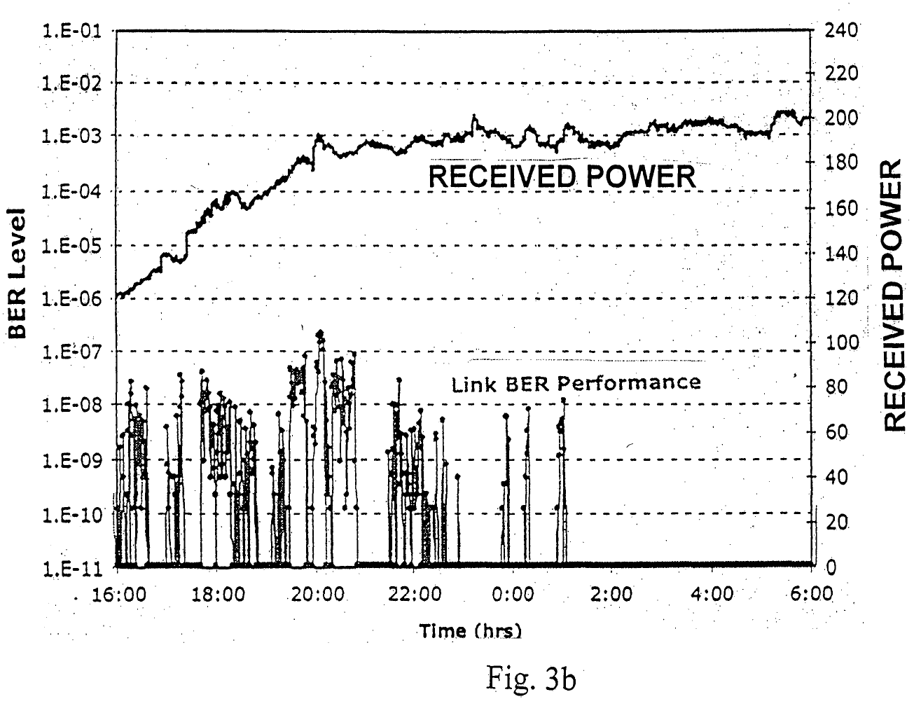

Shown in FIG. 3a is an experimental graph depicting the BER values and average received power received at the receiver as measured beginning at noon (12:00) and ending at midnight (0:00). As shown in FIG. 3a, the average received power is generally higher in the evening hours (18:00-0:00) than during the rest of the day. Generally, as the average received power increases, the BER improves. However, as shown in FIG. 3a, the average received power increases, but the BER decreases. FIG. 3b shows a similar graph taken on a different day and at different times during the day. As shown in FIG. 3b, the BER remains generally unaffected between the hours of 16:00-0:00, however the average received power continues to increase. As such, these exemplary graphs show that the average received power cannot be used to accurately or reliably characterize the state of a FSOW link and what impact it will have on the load. Hence, real-time BER statistics must be used to characterize the FSOW link and calculate the actual atmospheric attenuation.

In order to calculate the average received power, the instantaneous BER for a given time period (t) is first determined. The instantaneous BER is the ratio of erroneous bits received by the optical receiver 110 to the total number of total bits received by the optical receiver 110 in a specified time. One reference which discusses monitoring the BER is U.S. Ser. No. 60/399,657 “Proactive Techniques for Sustenance of High-Speed Fixed Wireless Links”. The instantaneous BER (t) was computed, for exemplary purposes only at one-minute intervals, using equation 2 below.

$$Instantaneous BER ( t ) = \frac{DifferentialErrorCount ( t , t - 1 )}{60 * DataRate} \qquad ( Equation 2 )$$

The DataRate is equal to the value of R₁ used in the first block 7 for the FSOW link when calculating the BER for the FSOW link, and the value for R₂ is used when calculating the BER for the RF link. As aforementioned, for experimental purposes, 622 Mbps was used for R₁ and 0 Mbps was used for R₂. The Differential Error Count (t, t−1) in equation 1 is found using the following equation 3:

DifferentialErrorCount(t,t−1)=CumulativeErrorCount(t)−CumulativeErrorCount(t−1) (Equation 3)

In equation 3, the Cumulative Error Count (t) is the total number of bit errors in a specified time period starting at an initial time t=0 through a time (t). The cumulative Error Count (t−1) is the cumulative number of bit errors in a specified time period starting at the initial time t=0 through the time (t−1). Note that the time (t−1) occurs prior to the time (t). The difference between the Cumulative Error Count (t) and Cumulative Error Count (t−1) yields the Differential Error Count (t, t−1). The measuring device 116 coupled to the RF receiving antenna 106 and optical receiver 110 is used to periodically measure and record the cumulative bit errors on the RF link and the FSOW link over several time periods. Although one-minute intervals were used, other time-intervals may be used as well depending on the application. Commercially available measuring devices which may be used to measure the number of error counts in a given time period are readily available from for example, Agilent Technologies.

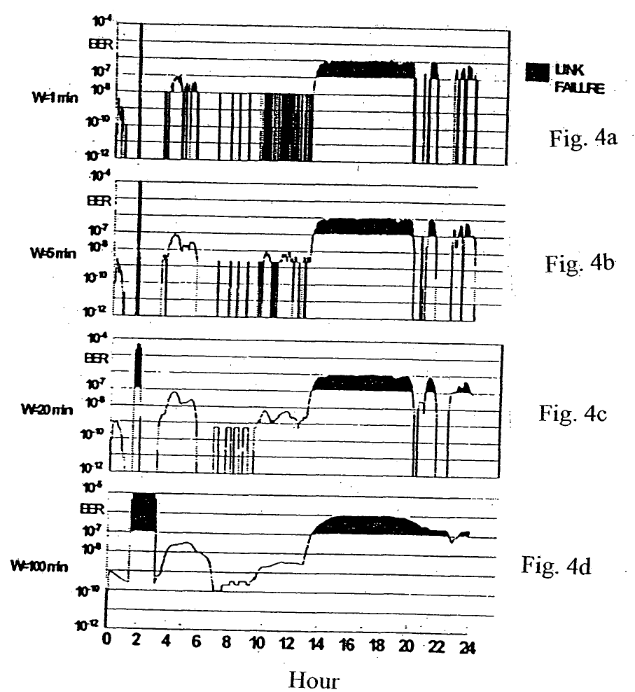

The measuring device 116 takes the value for Differential Error Count (t, t−1) and calculates the instantaneous BER (t) using equation 2 in minute intervals. The measuring device 116 then creates a window (W) over which the recorded instantaneous BER (t) values are averaged. For Example, shown in FIGS. 4a-4d, values for W of 1, 5, 20, and 100 minutes are used, respectively for the FSOW link. As aforementioned, one-minute intervals were experimentally used. This means that when W=5 minutes, the five instantaneous values of the BER in a 5 minute block are computed and averaged. This results in one averaged BER value for the 5-minute block, which is plotted. In this way, using W=5 minutes, 288 points will be plotted for a 24 hour period. In FIGS. 4a-4d, the x-axis represents each hour in a 24-hour period, and the y-axis represents the averaged BER value.

Shown in FIGS. 4a-4d are graphs of the windows (W) over which the BER values found in the second block 9 of the ILA algorithm 3 are averaged using the measuring device 116. The darkened areas represent an interval in which the averaged BER value exceeded the allowable BER value of 10⁻⁷. From FIGS. 4a-4d it can be seen that short window lengths of W=1 minute or 5 minutes, result in a high rate of changes in the average BER value caused by temporary line-of-site problems. Using such a short window is therefore undesirable because such frequent changes in the average BER value may cause the DLS algorithm 5, discussed later, to unnecessarily partition part of the load from the FSOW link to the RF link, increasing the processing power needed, which is costly.

Furthermore, it can be seen that long window lengths of W=100 minutes, may filter out important information. This can lead to an inaccurate representation of the link availability leading to data loss, which is undesirable. However, an intermediate window length of W=20 minutes appears to be the best balance between filtering out the unnecessary average BER value oscillations, while still retaining the necessary data.

The average BER value for each time window found by the measuring device 116 is then transmitted from the RF feedback transmitter 112 to the RF feedback receiver 114 where the algorithm 1 implements this data. Since the data for the average BER value only consists of numerical values it is possible to use a low data rate on the order of several kilobits.

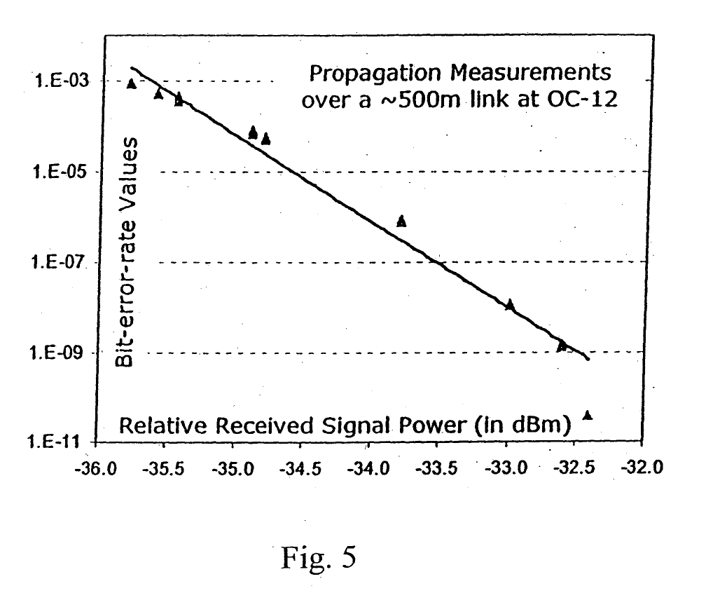

The algorithm 1 then uses the graph shown in FIG. 5 to convert the average BER value to the average received power of the load at the optical receiver 110. Shown in FIG. 5 is the relationship between the average BER value for a FSOW link and the average received power. The x-axis represents the average received power in dBmw and the y-axis represents the average BER value. The relationship between the BER and average received power in FIG. 5 is a direct 1:1 linear relationship. The graph shown in FIG. 5 is an exemplary graph. The values found in this graph are equipment specific and found by calibrating the equipment and using a data rate of 622 Mbps. Graphs showing the relationship between the BER and average received power for different loads or equipment on the FSOW link, can be readily generated by those skilled in the art. By using the known transmitted power in equation 1 and the average received power found using the graph in FIG. 5, the actual atmospheric attenuation can be calculated using equation 1.

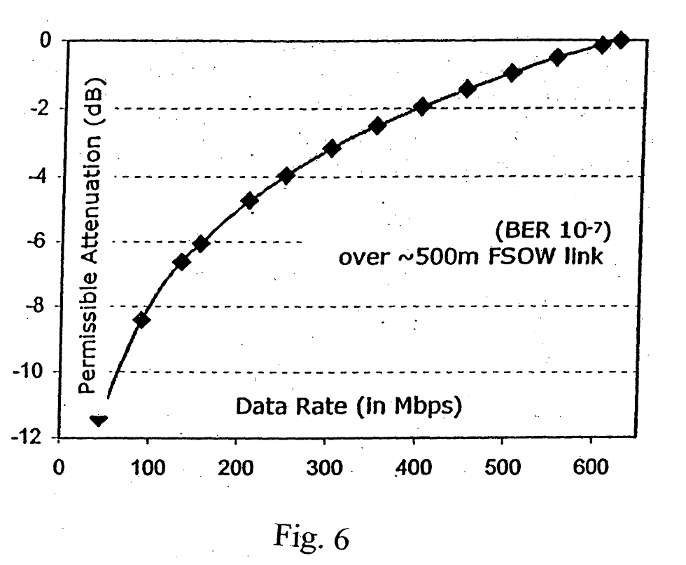

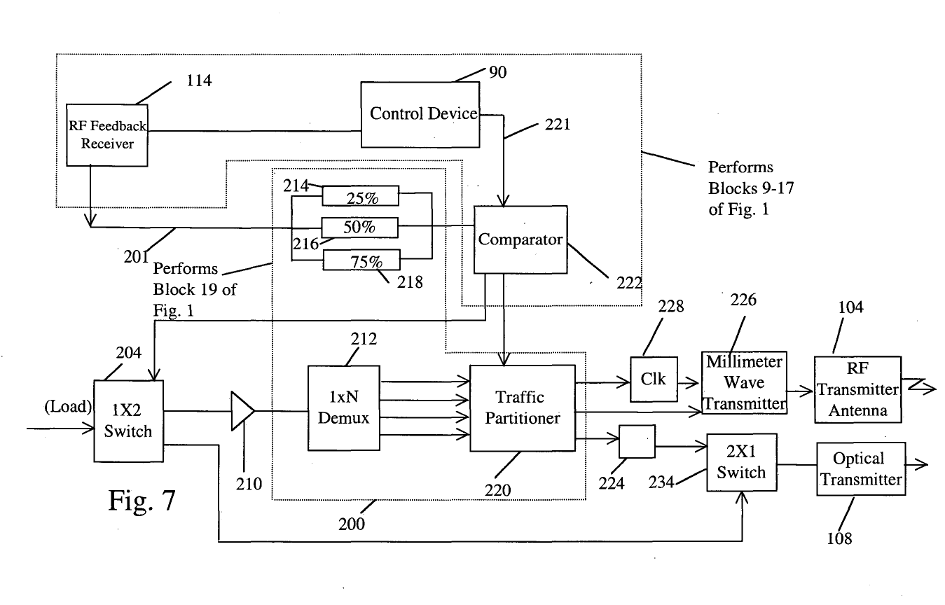

Next, the third block 11 of the ILA algorithm 3 computes the permissible attenuation for the FSOW and RF link. The permissible atmospheric attenuation for the FSOW link is calculated by using the graph shown in FIG. 6. The x-axis of the graph represents the load and the y-axis of the graph represents the permissible attenuation. As aforementioned, the load for the FSOW link was 622 Mbps. Also, note that this graph is specific to having a BER of 10⁻⁷. Graphs showing the permissible atmospheric attenuation of RF links are readily available as are other graphs showing the permissible attenuation with various loads and a BER threshold other than 10⁻⁷. In addition, it should be noted that general equations 4 and 5 below, may be used to calculate the permissible atmospheric attenuation of the FSOW link and RF link, respectively, by directly measuring the average received power.

Pᵣ=Pₜ●e^{-yd}●L (Equation 4)

Pᵣ=average received power by optical receiver 110

Pₜ=transmitted power by optical transmitter 108

e^{-yd}=Lₚₑᵣₘ(FSOW)=Permissible attenuation

$$γ = atmospheric attenuation constant = \frac{3.91}{V} {( \frac{λ}{500 nm} )}^{- δ}$$

λ=wavelength in nanometers

V=visibility in kilometers

d=distance between optical transmitter 108 and optical receiver 110

L=loss due to optical components, scintillation, and pointing losses.

Pᵣ=P_{T}●G_{T}●G_{R}●L_{S}●L_{Perm}(RF) (Equation 5)

Pₜ=transmitted power by RF transmitter 104

Pᵣ=received power by RF receiver 102

Gₜ=transmitter antenna 104 gain

Gᵣ=receiver antenna 102 gain

Lₚₑᵣₘ(RF)=atmospheric attenuation

$${L}_{s} = free space path loss = {( \frac{λ}{4 π d} )}^{2}$$

d=distance between RF transmitter 104 and RF receiver 102

λ=wavelength in nanometers

Next, the ILA algorithm 3 compares the permissible atmospheric attenuation values found in the third block 11 with the actual atmospheric attenuation values found in the second block 9. The fourth block 13 compares the actual atmospheric attenuation of the FSOW link found in the second block 9 with the permissible atmospheric attenuation of the FSOW link found in the third block 11. If desired, when the actual atmospheric attenuation of the FSOW link exceeds the permissible atmospheric attenuation of the FSOW link, then fifth block 15 can be used to determine whether the actual atmospheric attenuation of the RF link found in the second block 9 exceeds the permissible atmospheric attenuation of the RF link found in the third block 11. Similarly, if in the fourth block 13 the actual atmospheric attenuation of the FSOW link does not exceed the permissible atmospheric attenuation of the FSOW link, then the sixth block 17 can be used to determine whether the actual atmospheric attenuation of the RF link exceeds the permissible atmospheric attenuation of the RF link. Based on the data obtained in the fourth, fifth, and sixth blocks 13, 15, 17, there are four possible outcomes.

Case 1. The actual atmospheric attenuation on the FSOW and RF links is less than the permissible atmospheric attenuation on the FSOW and RF links, and the FSOW link can transmit the entire load and the RF link can transmit the entire load.

Case 2. The actual atmospheric attenuation on the FSOW and RF links is greater than the permissible atmospheric attenuation on the FSOW and RF links, and the FSOW link cannot transmit the entire load and the RF link can transmit the entire load.

Case 3. The actual atmospheric attenuation on the FSOW link is greater than the permissible atmospheric attenuation on the FSOW link and the actual atmospheric attenuation on the RF link is less than the permissible atmospheric attenuation on the RF link. The FSOW link cannot transmit the entire load and the RF link can transmit a portion of the load.

Case 4. The actual atmospheric attenuation on the FSOW link is less than the permissible atmospheric attenuation on the FSOW link and the actual atmospheric attenuation on the RF link is greater than the permissible atmospheric attenuation on the RF link. The FSOW link can transmit the entire load and the RF link cannot transmit a portion of the load.

Based on the above four outcomes, the DLS algorithm 5 makes an appropriate decision. In the event of case 1, the ninth block 25 of the DLS algorithm 5 will do nothing since the FSOW link is transmitting the maximum load, 622 Mbps, as an example. In the event of case 2, the tenth block 23 attempts to reduce the load on both the FSOW link and the RF link in an attempt to restore them. Using an algorithm to attend to both of these situations is well known. It is the subject matter of cases 3 and 4 that is of particular interest.

Also, it should be understood from the outset that the technique of switching a portion of the load from the FSOW link to the RF link is applicable even if the exact parameters associated with the RF link are not known. Specifically, the algorithm 1 may proceed from block 13 directly to block 15 in an attempt to restore the FSOW link. Although it is preferred to know the status of the RF link to know what portion of the FSOW link the RF link can support, it is still possible to attempt to partition a portion of the load on the FSOW link to the RF link. As previously discussed, FSOW links and RF links are complementary with respect to weather sensitivity. As such, if the attenuation on the FSOW link is too high as a result of weather conditions, the RF link will likely be available. For ease of understanding, the circuitry described below can be used to attempt to partition a portion of the load from the FSOW link to the RF link without knowing the parameters of the RF link.

In the event the actual atmospheric attenuation of the FSOW link is greater than the permissible attenuation on the FSOW link, the seventh block 19 of the DLS algorithm 5 attempts to bring the FSOW link up by switching a portion of the load from the FSOW link to the RF link. This can be done as incremental load shifting. The size of the increments directly affects link utilization and availability. The finer the increments the better the utilization, however, the tradeoff is that more expensive circuitry must be used. For experimental purposes, increments of 25% or R₁/4 were used. As aforementioned, the initial load on the FSOW link was 622 Mbps, so the incremental size would be about 155 Mbps. The DLS algorithm 5 can be activated periodically to shift a portion of the load from the FSOW link to the RF link depending on how frequently weather conditions change. However, unnecessary operation may result in processing delays, and infrequent operation may result in link failure due to inaccurate weather conditions as previously discussed with reference to FIGS. 4a-4d.

In order to shift a portion of the load from the FSOW link to the RF link, a control circuit 200, as shown in FIG. 7 can be used. As shown in FIG. 2, the circuit 200 is coupled to the transmitter station 100. The RF feedback receiver 114 receives the averaged BER value from the RF feedback transmitter 112. In FIG. 7, the RF feedback receiver 114 is coupled to a received signal strength intensity (RSSI) line 201. The RF feedback receiver 114 provides the averaged BER value to the algorithm 1 in the control device 90. Using the graph shown in FIG. 5, the algorithm 1 and control device 90 provide the RF feedback receiver 114 with a value relating the averaged BER value to the power received by the optical receiver 110. The RF feedback receiver then generates a signal with a magnitude equal to the signal received by the optical receiver 110 and provides this signal to a series of latches 214, 216, 218. Each latch 214, 216, 218 has a different threshold level, which when exceeded by the signal on the line 201, causes the latch whose threshold has been exceeded to turn on and send a signal to the comparator 222. The percentage of the load on the FSOW link to be transferred to the RF link is determined by which of the latches 214, 216, 218 are activated. For exemplary purposes only, latch 214 corresponds to 25%. If only the latch 214 is activated then a signal is sent through the comparator 222 to the traffic partitioner 220 to transfer 25% of the load from the FSOW link to the RF link. The specific threshold voltages used to activate the latches 214, 216, 218 are purely a matter of design and preference. The number of latches used is also a matter of design and preference. As aforementioned, when the control device 90 receives the average BER value from the RF feedback receiver 114, the algorithm 1 converts that average BER value to the corresponding numerical value of the received signal strength using the graph in FIG. 5. Then, as aforementioned, the algorithm 1 uses equation 1 to calculate the actual atmospheric attenuation (See block 9 of FIG. 1). The algorithm 1 then compares the permissible and actual atmospheric attenuation of the FSOW link (See block 13 of FIG. 1). If the actual atmospheric attenuation is less than the permissible atmospheric attenuation, a first signal is sent to the comparator 222. If the actual atmospheric attenuation is greater than the permissible atmospheric attenuation, a second signal is correspondingly sent to the comparator 222.

In the event the comparator 222 receives the first signal, the comparator 222 sends a signal to the 1×2 switch 204 indicating that the entire load is to be coupled directly to the 2×1 switch 234. The 2×1 switch 234 couples the load to the optical transmitter 108, where the load is sent over the FSOW link.

In the event, the comparator 222 receives the second signal, the comparator 222 sends a signal to the 1×2 switch 204, indicating the load is to be directed through an amplifier 210 to a 1×N demultiplexer 212. The value of N for the demultiplexer 212 is equal to 1 divided by the increment percentage and is typically set to correspond to the increments used in the latches. The aforementioned example used increments of 25%. This would yield a value of N equal to 4. For a value of N=4, the demultiplexer 212 partitions the load into 4 equal parts, each part comprising 25% of the load, which are coupled to the traffic partitioner 220. Also, when the comparator 222 receives the signal of case two, the signal generated by the latches 214, 216, 218 is coupled to the traffic partitioner 220. The signal received by the traffic partitioner 220 from the latches 214, 216, 218, determines what percentage of the load is partitioned to a laser diode 224 and what percentage of the load is partitioned to a millimeter wave transmitter 226. If only the latch 214 corresponding to 25% was activated as described earlier, then the traffic partitioner 220 couples 75% of the load to the laser diode 224 and 25% of the load to the millimeter wave transmitter 226. A clock 228 is also coupled between the millimeter wave transmitter 226 and the traffic partitioner 220. The clock 228 is used to control the data rate of the partitioned load sent to the millimeter wave transmitter 226. The millimeter wave transmitter 226 is coupled to the RF transmitting antenna 104 to send the partitioned load for the RF link over the RF link. Also, the laser diode 224 is coupled to the 2×1 switch 234 that couples the partitioned load for the FSOW link to the optical transmitter 108 to be sent over the FSOW link. Although the control circuit 200 is directed towards the situation where the actual atmospheric attenuation is greater than the permissible atmosphere attenuation of the FSOW link, the algorithm 1 and control circuit 200 could be easily configured to partition a portion of the load from the RF link to the FSOW link.

Let it be understood that the foregoing description is only illustrative of the invention. Various alternatives and modifications can be devised by those skilled in the art without departing from the spirit of the invention. Accordingly, the present invention is intended to embrace all such alternatives, modifications, and variances which fall within the scope of the appended claims.

1. A method for maintaining an optical wireless link comprising the steps of:
sending a load on the optical wireless link between a transmitter and a receiver;
computing at least one quality indicator of the optical wireless link; and
in response to the at least one quality indicator, automatically partitioning the load and placing at least one partition on a RF link.

2. The method of claim 1, wherein the step of computing at least one quality indicator comprises the step of determining a bit error rate of the load on the optical wireless link.

3. The method of claim 2, wherein the step of computing at least one quality indicator further comprises the step of computing actual atmospheric attenuation of the optical wireless link by using the determined bit error rate of the load on the optical wireless link.

4. The method of claim 3, wherein the step of computing at least one quality indicator further comprises the step of computing permissible atmospheric attenuation of the optical wireless link.

5. The method of claim 4, further comprising the step of determining whether the actual atmospheric attenuation is greater or less than the permissible atmospheric attenuation.

6. The method of claim 5, wherein the step of partitioning the load comprises the step of partitioning a portion of the load from the optical wireless link to a RF link when the actual atmospheric attenuation is greater than the permissible atmospheric attenuation.

7. The method of claim 6, wherein the step of partitioning the load further comprises the step of incrementally increasing the number of partitions placed on the RF link.

8. An apparatus for maintaining an optical wireless link comprising:
a transmitter and receiver, wherein the transmitter transmits a load over the optical wireless link to the receiver;
a measuring device coupled to the receiver, the measuring device measuring at least one quality indicator of the optical wireless link;
a control device which executes an algorithm, the algorithm providing a signal based on the at least one quality indicator to partition the load and place at least one partition on a RF link;
a control circuit receiving the signal, partitioning the load, and placing at least one partition on the RF link; and
a feedback link, the feedback link sending the at least one quality indicator from the measuring device to the control device.

9. The apparatus of claim 8, wherein the at least one quality indicator is a bit error rate of the load on the optical wireless link.

10. The apparatus of claim 9, wherein the algorithm uses the bit error rate of the load to determine actual atmospheric attenuation of the optical wireless link.

11. The apparatus of claim 10, wherein the algorithm determines the permissible atmospheric attenuation of the optical wireless link.

12. The apparatus of claim 11, wherein the control circuit partitions the load and places at least one partition on the RF link when the actual atmospheric attenuation is greater than the permissible atmospheric attenuation.

13. The apparatus of claim 8, wherein the feedback link is a RF feedback link.

14. The apparatus of claim 8, wherein the feedback link is an optical wireless link.

15. A method for maintaining an optical wireless link comprising the steps of:
sending a load on the optical wireless link between a transmitter and a receiver;
determining at least one quality indicator of the optical wireless link, wherein the at least one quality indicator comprises actual atmospheric attenuation of the optical wireless link, the actual atmospheric attenuation determined by measuring a bit error rate of the load on the optical wireless link; and
in response to the at least one quality indicator, automatically partitioning the load and placing at least one partition on a RF link.

16. The method of claim 15, wherein the step of computing at least one quality indicator further comprises the step of computing permissible atmospheric attenuation of the optical wireless link.

17. The method of claim 16, further comprising the step of determining whether the actual atmospheric attenuation is greater or less than the permissible atmospheric attenuation.

18. The method of claim 17, wherein the step of partitioning the load comprises the step of partitioning a portion of the load from the optical wireless to the RF link when the actual atmospheric attenuation is greater than the permissible atmospheric attenuation.

19. The method of claim 18, wherein the step of partitioning the load comprises the step of incrementally partitioning the load between the optical wireless link and the RF link.
